(19) United States
(12) Patent Application Publication
(10) Pub. No.: US 2011/0298621 A1
(43) Pub. Date: Dec. 8, 2011

(54) SYSTEM AND METHOD FOR GENERATING ALERTS

(76) Inventor: Lokesh Shanbhag, Bangalore (IN)

(21) Appl. No.: 13/151,856

(22) Filed: Jun. 2, 2011

(30) Foreign Application Priority Data
Jun. 2, 2010 (IN) 1532/CHE/2010

(51) Int. Cl. G08B 23/00

(52) U.S. Cl. 340/573.1

(57) ABSTRACT

In one embodiment, a method of generating alerts in a patient monitoring system is provided. The method comprises steps of monitoring a physiological parameter of interest within a plurality of physiological parameters, tracking data values of the physiological parameter for each predetermined interval, determining a data range for data values of the physiological parameter, each data range comprising a first limit and a second limit, comparing the data values of the physiological parameter with the data range and generating a visual alert when the data value of the physiological parameter falls outside the data range.

### FIELD OF INVENTION

The invention generally relates to monitoring systems and more particularly to patient monitoring systems that monitor the physiological parameters of patients at a health-care facility.

### BACKGROUND OF THE INVENTION

In typical patient monitoring systems, majority of the patient monitoring data is shown in a usual fashion. Any irregularities in the patient monitoring data are typically highlighted as audible alarms. Since these are treated and checked through only by alarms, there is lack of visual indication following the detection of an irregularity. Thus, either there is no change in the display observed by a user, or the changes are routine and not of interest. Because of this, it is very difficult for the user to maintain attention when observing the display.

On the other hand, a record of the alarms serviced is rarely maintained making it difficult for the user to access historic records of irregularity detection.

Hence there exists a need for a system and method that provides better warning and visual notification of patient emergencies and also provides better historic records of physiological parameters.

### BRIEF DESCRIPTION OF THE INVENTION

The above-mentioned shortcomings, disadvantages and problems are addressed herein which will be understood by reading and understanding the following specification.

In one embodiment, a method of generating alerts in a patient monitoring system is provided. The method comprises steps of monitoring a physiological parameter of interest within a plurality of physiological parameters, tracking data values of the physiological parameter for each predetermined interval, determining a data range for data values of the physiological parameter, each data range comprising a first limit and a second limit, comparing the data values of the physiological parameter with the data range and generating a visual alert when the data value of the physiological parameter falls outside the data range.

In another embodiment, a patient monitoring system capable of generating alerts is provided. The patient monitoring system comprises an acquisition unit configured for acquiring signals representing one or more physiological parameters of a patient, a processing unit coupled to the acquisition unit, the processing unit configured for detecting the occurrence of an event and for generating a visual alert upon detecting the event and a display unit coupled to the processing unit, the display unit configured for selectively displaying a full image and a partial image superimposed on the full image, the partial image utilizing a fraction of the display area for displaying the visual alert.

In yet another embodiment, a computer program product comprising computer-readable storage media encoding program instructions for execution on a general-purpose computer system is provided. The program instructions are configured for detecting events in a patient monitoring system and the program instructions comprise code for monitoring a physiological parameter of interest within a plurality of physiological parameters, code for tracking data values of the physiological parameter for each predetermined interval, code for determining a data range for the data values of the physiological parameter, each data range comprising a first limit and a second limit, code for comparing the data values of the physiological parameter with the data range and code for generating a visual alert when the data value of the physiological parameter falls outside the data range.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a block diagram of a patient monitoring system capable of generating alerts as described in an embodiment;

FIG. 2 shows a flow chart depicting a method of generating alerts in a patient monitoring system as described in one embodiment; and

FIG. 3 shows a flow chart depicting a method of generating alerts in a patient monitoring system as described in another embodiment.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The system and method of patient monitoring described in the invention attempt to overcome the problem mentioned above by using computer processing to analyze the patient data and determine any irregularities therein. User attention can then be drawn to the events that are detected. One method of drawing attention to particular events is to provide visual alerts.

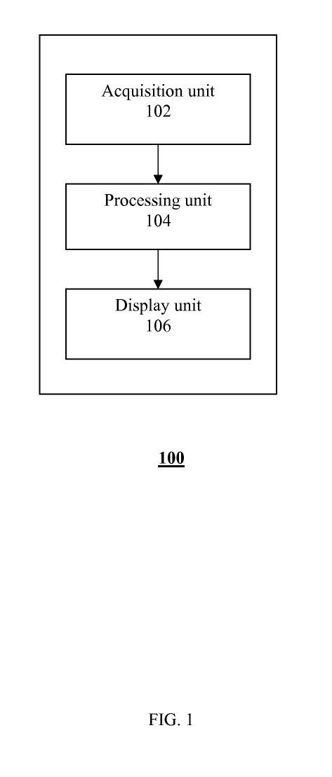

Turning now to FIG. 1, a patient monitoring system 100 capable of generating alerts is provided. The patient monitoring system 100 comprises an acquisition unit 102, a processing unit 104 coupled to the acquisition unit 102 and a display unit 106 coupled to the processing unit 104. The acquisition unit 102 is configured for acquiring signals representing one or more physiological parameters of a patient. The processing unit 104 is configured for detecting the occurrence of an event and for generating a visual alert upon detecting the event. The display unit 106 has the capability of delivering the visual alert so generated. The display unit 106 is configured for selectively displaying a full image and a partial image superimposed on the full image. The partial image utilizes a fraction of the display area for displaying the visual alert.

The display unit 106 comprises a general purpose, multi-parameter, portable or non-portable monitor device that is employed to provide one or more signals indicating one or more physiological parameters being monitored. The physiological parameters being monitored include but are not limited to Electrocardiogram (ECG), Electromyogram (EMG), Electroencephalogram (EEG), Oxygen Saturation in blood (SaO2), systolic blood pressure, diastolic blood pressure, pulse rate, respiration rate, temperature, and oxygen saturation.

The user may choose one or more physiological parameters to be graphed. The graphical data comprises a waveform plotted using the data values of the physiological parameter. The sensors for sensing the physiological parameters also make waveforms of the physiological parameters being monitored, available to the user. In dealing with physiological parameters that are plotted in a waveform, a standard waveform is identified based on the standard range of data values.

The standard waveform is relevant in determining whether an alert should be generated. The waveforms of the selected physiological parameters are monitored with respect to the standard waveform. When a deviation is detected from the standard waveform, an alert is generated. As used herein, unless otherwise noted, the term “alert” means a visual alert.

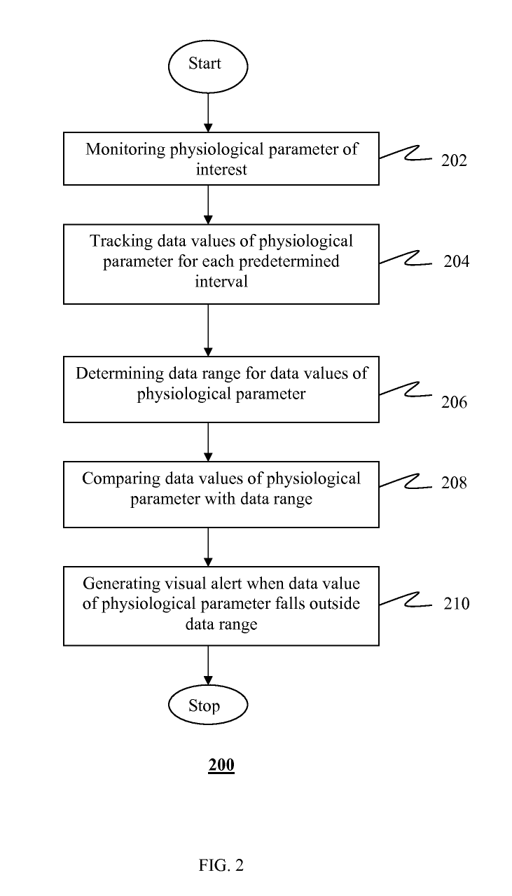

FIG. 2 shows an illustrative method 200 for generating alerts in patient monitoring system 100. The method 200 comprises steps of monitoring a physiological parameter of interest within a plurality of physiological parameters at step 202, tracking data values of the physiological parameter for each predetermined interval at step 204, determining a standard range for data values of the physiological parameter at step 206, each standard range comprising a first limit and a second limit, comparing the data values of the physiological parameter with the standard range at step 208 and generating a visual alert when the data value of the physiological parameter falls outside the standard range at step 210.

The step 210 of generating the visual alert comprises zooming at least one of the data value, an alarm text and graphical data corresponding to the physiological parameter for a predetermined time period.

The zoom-in display provides more detailed information on the irregularity observed while monitoring the selected physiological parameter. The waveforms are auto zoomed with manual option of ++ zooming or 2× zooming.

In the zoom-in display, the data to be presented in the visual alert is scaled up to provide an enlarged view of the information corresponding the physiological parameter. The enlarged view of the waveform corresponding the physiological parameter showing the irregularity helps the caregiver in making quick analysis and providing better diagnosis.

The user may set both the first and second limit for any or all physiological parameters being monitored. The values for the first and second limit can be stored on a central server system 100 connecting various patient monitors in the healthcare facility. However, the values can be changed from any patient monitor on the network.

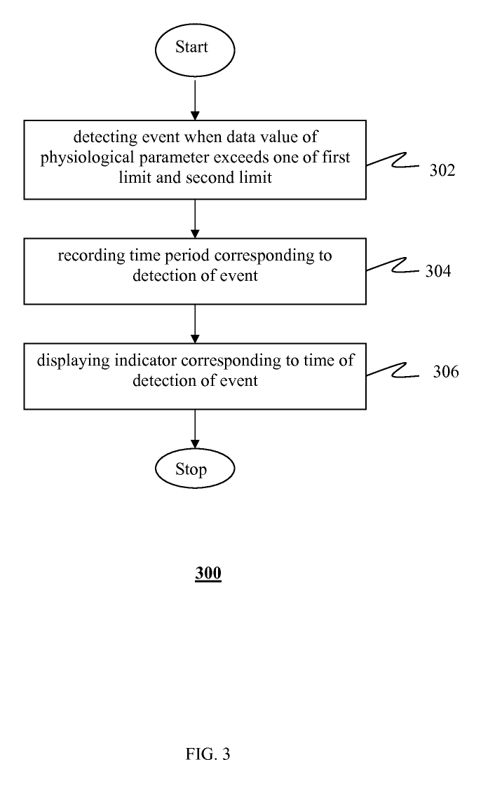

The method 200, as shown in FIG. 3, further comprises detecting an event when the data value of the physiological parameter exceeds one of the first limit and the second limit at step 302. The method further comprises recording the time period corresponding to the detection of the event at step 304 and displaying an indicator corresponding to the time of detecting the event at step 306. The indicator comprises one of a graphical indicator, numerical indicator and textual indicator.

The indicators may be saved as a part of the patient history or patient's digital record. The indicators displayed in the patient history or the digital patient record, may serve as a marker for later review and analysis by the user. This allows the user to view historical trends of the monitored physiological parameters. Thus, the indicator may be used as a diagnostic tool for a clinician who is notified of the automated diagnosis upon the next review of the digital patient record.

In one embodiment, two separate sets of limits can be defined by the user. The two separate sets of limits help distinguish between a warning alert and a critical alert. The warning alert can be generated when the data value of the physiological parameter crosses one of the limits among the first set of limits and the critical alert can be generated when the data value of the physiological parameter crosses one of the limits among the second set of limits. This provides a two stage alert system 100 capable of indicating the amount of deviation from the standard range.

In one embodiment, color-coding can be employed while displaying the visual alert. For example, in a normal condition, the visual alert has a black background color and the waveforms indicating the various physiological parameters are green provided the physiological parameters are within the standard range representing a non-emergency condition. The warning signs may be shown in yellow color and the critical signs may be shown in red color. This use of green for normal condition helps to make sure that the yellow and red for lesser and greater level of emergency conditions stand out when they do occur.

Alternatively, the background of the visual alert may also be changed. The visual alert may have a red background when the physiological parameter being monitored shows a critical sign, a yellow background when the physiological parameter shows a warning sign, a green background when the data values of the physiological parameter being monitored are within the standard range and in general the display screen may have a black background.

In another embodiment, the visual alert for each physiological parameter may be selected to be of different color. For example, the visual alert for body temperature may be indicated in red whereas the visual alert for blood pressure may be indicated in blue.

The visual alert may be displayed for a predetermined time period. However, if the user wishes to end the display of the visual alert prior to the completion of the predetermined time period, the user may be provided with an exit option to close the visual alert and return to the display screen.

If there is more than one visual alert, multiple windows may be shown, overlaid and offset to provide the user with an indication that there are plurality of alerts. Access to each window can be permitted by employing suitable accessing technique such as the mouse click.

In one embodiment, a computer system 100 that can perform the method described herein in order to detect irregularities in the physiological parameters monitored by the patient monitoring system 100 is provided. The computer system 100 includes a processing unit 104 that comprises a detection program, which makes the processing unit 104 operable to detect events in the physiological parameters monitored by the patient monitoring system 100 by performing the method described herein.

A data storage unit coupled to the processing unit 104 contains detection program for detecting events in the physiological parameters monitored by the patient monitoring system 100. The detection program comprises an acquisition module for monitoring a physiological parameter of interest, a tracking module for tracking data values of the physiological parameter for each predetermined interval, a definition module for determining a standard range of data values for the physiological parameter, a comparison module for comparing the data values of the physiological parameter with the standard range and an alert module for generating a visual alert when the data value of the physiological parameter falls outside the determined standard range.

In one embodiment, the user may choose which physiological parameters are monitored (e.g. patient may only need to have BP and pulse monitored). The acquisition module monitors the physiological monitors that are selected by the user for monitoring. The definition module enables the user to define and/or change one or more of the first limit and the second limit.

The alert module can begin evaluating the data values of various physiological parameters tracked by the tracking module to determine whether one or more of the data values are outside the standard range. If so, the alert module can generate the alert, which is presented to the user. Further, the alert module can provide information on the alert such as the type of alert and highlight the physiological parameter that has caused the alert, and/or the like, for evaluation and potential action by the user. The visual alert may also include the data value of the physiological parameter, alarm text and waveform of the physiological parameter.

A technical effect of the invention includes detecting irregularities in the physiological parameters monitored by the patient monitoring system and thereby generating a visual alert notifying a user of the irregularities.

Some of the advantages of the system and method of generating alerts in patient monitoring are described below.

The visual alert provides a quick indication on the irregularities observed in the physiological parameters being monitored. The visual alert provides a real time indication that there is an irregularity, how severe the irregularity is (that is, whether it is at a warning level or a critical level) and which type of the physiological parameter is showing the irregularity. This helps a caregiver in providing immediate attention to the patient.

The display screen displays values of all the physiological parameters that are selected to be monitored whereas the visual alert displays only the values of the physiological parameters that are out of normal range. Furthermore, the zoom-in screen displays data in both digital form and analog form showing both a numeric and abstract representation. This provides an intuitive grasp of the information presented, eliminating the time lag, confusion, and user error associated with information, which must be skillfully interpreted. Therefore, the visual alert provides a particularly useful presentation of information to those who must monitor the situation leading to a more immediate recognition of where a warning situation exists and what the nature of it is likely to be.

In various embodiments of the invention, a method of providing visual alert in a patient monitoring system and a patient monitoring system providing a visual alert are described. However, the embodiments are not limited and may be implemented in connection with different applications. The application of the invention can be extended to other areas where mission critical displays are involved. The invention provides a broad concept of providing a visual alert, which can be adapted in a similar monitoring system. Accordingly, while the invention is illustrated in connection with a medical monitor, it may employed for monitoring the operation of other complicated systems with a large number of variables, such as, aircraft, flight control tower systems, nuclear power plants, electrical grids, and complex industrial manufacturing or processing operations. The design can be carried further and implemented in various forms and specifications.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of generating alerts in a patient monitoring system, the method comprising:
monitoring a physiological parameter of interest within a plurality of physiological parameters;
tracking data values of the physiological parameter for each predetermined interval;
determining a data range for data values of the physiological parameter, each data range comprising a first limit and a second limit;
comparing the data values of the physiological parameter with the data range; and
generating a visual alert when the data value of the physiological parameter falls outside the data range.

2. The method of claim 1, wherein generating the visual alert comprises zooming the data value corresponding to the physiological parameter for a predetermined time period.

3. The method of claim 1, wherein generating the visual alert comprises zooming an alarm text corresponding to the physiological parameter for a predetermined time period.

4. The method of claim 1, wherein generating the visual alert comprises zooming graphical data corresponding to the physiological parameter for a predetermined time period.

5. The method of claim 4, wherein the graphical data comprises a waveform plotted using the data values of the physiological parameter.

6. The method of claim 1, further comprising detecting an event when the data value of the physiological parameter exceeds one of the first limit and the second limit.

7. The method of claim 6, further comprising recording the time period corresponding to the detection of the event.

8. The method of claim 7, further comprising displaying an indicator corresponding to the time of detecting the event.

9. The method of claim 8, wherein the indicator comprises one of a graphical indicator, numerical indicator and textual indicator.

10. A patient monitoring system capable of generating alerts, the patient monitoring system comprising:
an acquisition unit configured for acquiring signals representing one or more physiological parameters of a patient;
a processing unit coupled to the acquisition unit, the processing unit configured for detecting the occurrence of an event and for generating a visual alert upon detecting the event; and
a display unit coupled to the processing unit, the display unit configured for selectively displaying a full image and a partial image superimposed on the full image, the partial image utilizing a fraction of the display area for displaying the visual alert.

11. The patient monitoring system of claim 10, wherein generating the visual alert comprises zooming the data value corresponding to the physiological parameter for a predetermined time period.

12. The patient monitoring system of claim 10, wherein generating the visual alert comprises zooming an alarm text corresponding to the physiological parameter for a predetermined time period.

13. The patient monitoring system of claim 10, wherein generating the visual alert comprises zooming graphical data corresponding to the physiological parameter for a predetermined time period.

14. The patient monitoring system of claim 13, wherein the graphical data comprises a waveform plotted using the data values of the physiological parameter.

15. A computer program product comprising computer-readable storage media encoding program instructions for execution on a general-purpose computer system, the program instructions configured for detecting events in a patient monitoring system, the program instructions comprising:
code for monitoring a physiological parameter of interest within a plurality of physiological parameters;
code for tracking data values of the physiological parameter for each predetermined interval;
code for determining a data range for the data values of the physiological parameter, each data range comprising a first limit and a second limit;
code for comparing the data values of the physiological parameter with the data range; and
code for generating a visual alert when the data value of the physiological parameter falls outside the data range.

16. The computer program product of claim 15, wherein code for generating the visual alert comprises code for zooming the data value corresponding to the physiological parameter for a predetermined time period.

17. The computer program product of claim 15, wherein code for generating the visual alert comprises code for zooming an alarm text corresponding to the physiological parameter for a predetermined time period.

18. The computer program product of claim 15, wherein code for generating the visual alert comprises code for zooming graphical data corresponding to the physiological parameter for a predetermined time period.

19. The computer program product of claim 18, wherein the graphical data comprises a waveform plotted using the data values of the physiological parameter.

20. The computer program product of claim 15, further comprising code for detecting an event when the data value of the physiological parameter exceeds one of the first limit and the second limit.

21. The computer program product of claim 20, further comprising code for recording the time period corresponding to the detection of the event.

22. The computer program product of claim 21, further comprising code for displaying an indicator corresponding to the time of detecting the event.

23. The computer program product of claim 22, wherein the indicator comprises one of a graphical indicator, numerical indicator and textual indicator.
